(19) United States
(12) Patent Application Publication
(10) Pub. No.: US 2025/0313190 A1
(43) Pub. Date: Oct. 9, 2025

(54) VEHICULAR DRIVING ASSIST SYSTEM WITH ROAD DEFECT DETECTION AND CATEGORIZATION

(71) Applicant: Magna Electronics Inc., Auburn Hills, MI (US)

(72) Inventors: Ramnath Baje Shenoy, Karnataka State (IN); Komal Jha, Karnataka State (IN); Riddha Choudhury, Gujarat State (IN)

(21) Appl. No.: 19/170,254

(22) Filed: Apr. 4, 2025

Related U.S. Application Data
(60) Provisional application No. 63/575,903, filed on Apr. 8, 2024.

(51) Int. Cl. B60W 30/02; B60W 10/18; B60W 10/20; B60W 50/14; G06F 16/29

(52) U.S. Cl. CPC B60W 30/02; B60W 10/18; B60W 10/20; B60W 50/14; G06F 16/29; B60W 2420/403; B60W 2420/408; B60W 2552/35; B60W 2556/50

(57) ABSTRACT

A vehicular driving assist system includes a sensor disposed at a vehicle and operable to capture sensor data. The vehicular driving assist system, responsive to processing at an ECU of sensor data captured by the sensor, detects a pothole in ahead of the vehicle. The vehicular driving assist system, responsive to detecting the pothole, determines severity of the detected pothole based at least in part on geographic-linked data that includes at least one of size, depth or shape of the detected pothole. At least partially based on the severity of the pothole, at least one of (i) a driver of the vehicle is alerted, (ii) steering of the vehicle is controlled to mitigate a wheel of the vehicle traveling over the detected pothole and (iii) braking of the vehicle is controlled to mitigate the wheel of the vehicle traveling over with the detected pothole.

### CROSS REFERENCE TO RELATED APPLICATION

The present application claims the filing benefits of U.S. provisional application Ser. No. 63/575,903, filed Apr. 8, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driving assist system includes a sensor disposed at a vehicle equipped with the vehicular driving assist system. The sensor senses exterior of the vehicle and is operable to capture sensor data. The system includes an electronic control unit (ECU) with electronic circuitry and associated software. Sensor data captured by the sensor is transferred to and is processed at the ECU. The vehicular driving assist system, responsive to processing at the ECU of sensor data captured by the sensor and transferred to the ECU, detects a pothole ahead of the vehicle. The vehicular driving assist system, responsive to detecting the pothole, determines severity of the detected pothole based at least in part on geographic-linked data, and the geographic-linked data includes at least one selected from the group consisting of (i) size of the detected pothole, (ii) depth of the detected pothole and (iii) shape of the detected pothole. At least partially based on the determined severity of the detected pothole, at least one selected from the group consisting of (i) a driver of the vehicle is alerted, (ii) steering of the vehicle is controlled to mitigate a wheel of the vehicle traveling over the detected pothole and (iii) braking of the vehicle is controlled to mitigate the wheel of the vehicle traveling over with the detected pothole.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates cameras and radar sensors;

FIGS. 2A-2E are perspective views of roads with various potholes;

FIG. 3 is a block diagram of the sensing system of FIG. 1;

FIG. 4 is another block diagram of the sensing system of FIG. 1; and

FIGS. 5A-5C are tables of pavement distress types and classifications.

### DESCRIPTION OF THE PREFERRED EMBODIMENTS

Roadway infrastructure is susceptible to structural degradation on account of material deterioration primarily caused by heavy traffic, harsh weather conditions, aging, poor construction quality, and/or lack of appropriate maintenance. This structural degradation often results in potholes. These potholes come in various sizes and shapes and pose a threat to vehicles driving along the road. For example, a small, shallow pothole might cause minor tire damage, while a large, deep pothole can cause significant damage to a vehicle's suspension system, wheels, and tires. Furthermore, potholes can lead to loss of vehicle control, increasing the risk of accidents. To add to this problem, a waterlogged road will make it even more difficult for the drivers to assess the presence and depth of a pothole, thus making it an even more dangerous condition. Standing water obscures the pothole, preventing drivers from visually gauging the severity of the road hazard. This lack of visibility can cause a driver to inadvertently drive over a severe pothole at a speed that causes damage or loss of control. Potholes filled with water are a significantly greater risk on highways, freeways, and expressways where the vehicle operates at higher speeds.

Many modern vehicles come equipped with technologies to scan the road ahead of the vehicle and determine the presence of such potholes. These systems may allow the vehicle to adapt its suspension in order to smoothen the ride. However, a pothole filled with water generally cannot be detected using these existing technologies. For example, camera-based systems rely on visual contrast and texture analysis, which are significantly degraded when a pothole is filled with water, as the water surface reflects the surrounding environment and obscures the pothole's features. Similarly, radar and lidar systems may struggle to accurately measure the depth of a water-filled pothole because the water surface can cause scattering and reflection of the radar or lidar signals. Ultrasonic sensors lack the operational range needed to scan the roadway far enough ahead of the vehicle. Therefore, a novel solution is required to resolve this issue.

Implementations herein use existing inputs from various vehicle sensors such as one or more cameras, radar sensors, and/or lidar sensor along with inputs from high-definition (HD) maps (e.g., ADASIS V3) to provide a fusion algorithm capable of detecting potholes as part of a Road Condition Monitoring (RCM) feature. Optionally, the detected potholes are classified based on a size, a shape, a depth, etc. Additionally, or alternatively, the potholes are classified as minor potholes, major potholes, or critical potholes. Based on the detection and classification of the pothole, the feature may warn the driver and/or take further action (e.g., slow the vehicle, steer the vehicle, adjust suspension, etc.) to avoid or mitigate the effects of the pothole.

These implementations provide several technical advantages. The fusion algorithm may improve detection accuracy by combining data from multiple sensor modalities, overcoming the limitations of individual sensors. For example, while a camera may struggle to see a water-filled pothole, the fusion algorithm can cross-reference high-definition map data or other geographic-linked data (e.g., from a map database) that indicates a pothole's previously recorded presence and size, depth, and/or severity rating/classification at that geographical location. This cross-referencing enhances reliability. The fusion approach also offers improved robustness against environmental conditions. While radar might be affected by rain, the fusion algorithm can rely more heavily on camera and high-definition map data in such circumstances. Moreover, the classification of potholes by severity (e.g., minor, major, critical) allows for a graduated vehicle response. A minor pothole may trigger a driver alert, while a critical pothole may initiate automatic emergency braking. This differentiated response enhances safety and optimizes vehicle control adjustments. As yet another example, the algorithm may predict a location and a depth of a water-filled pothole which allows the vehicle to begin preparing for the pothole encounter before the vehicle reaches the pothole.

A vehicle sensing system and/or driver or driving assist system and/or object detection system and/or alert system operates to capture sensor data exterior of the vehicle and may process the captured sensor data to detect objects at or near the vehicle and in the predicted path of the vehicle. The sensing system includes a processor or processing system that is operable to receive sensor data from one or more sensors (e.g., one or more cameras, radar sensors, and/or lidar sensors). Optionally, the system may provide an output to a display device for displaying images representative of the captured sensor data. Optionally, the sensor system may provide a display, such as a rearview display or a top down or bird's eye or surround view display or the like.

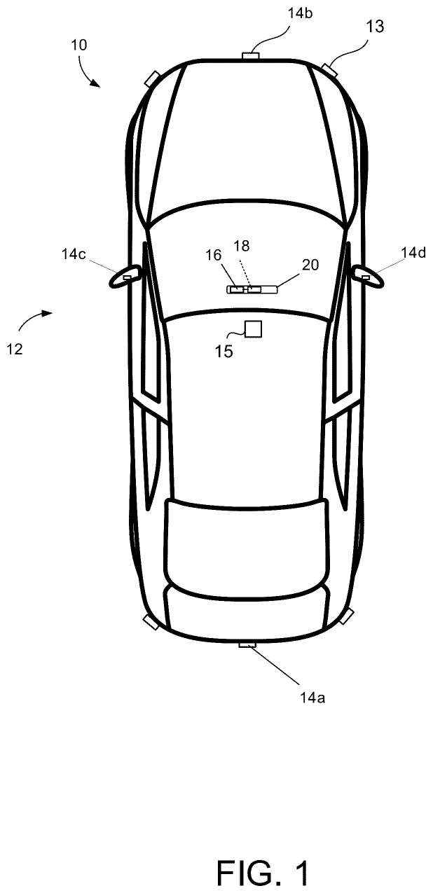

Referring now to the drawings and the illustrative embodiments depicted therein, a vehicle 10 includes an sensing system 12 that includes at least one exterior-viewing imaging sensor or camera, such as a rear backup camera or rearward-viewing imaging sensor or camera 14a (and the system may optionally include multiple exterior-viewing imaging sensors or cameras, such as a forward-viewing camera 14b at the front (or at the windshield) of the vehicle, and a sideward/rearward-viewing camera 14c, 14d at respective sides of the vehicle), which captures images exterior of the vehicle, with the camera having a lens for focusing images at or onto an imaging array or imaging plane or imager of the camera (FIG. 1). Optionally, a forward-viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). Optionally, the sensing system includes one or more radar sensors 13 and/or one or more lidar sensors 15. The sensing system 12 includes a control or electronic control unit (ECU) 18 having electronic circuitry and associated software, with the electronic circuitry including a data processor or image processor that is operable to process sensor data captured by the sensors, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

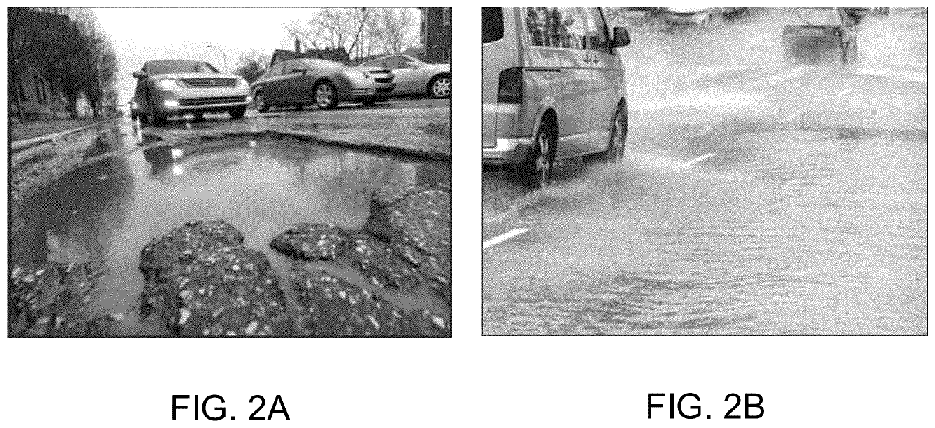

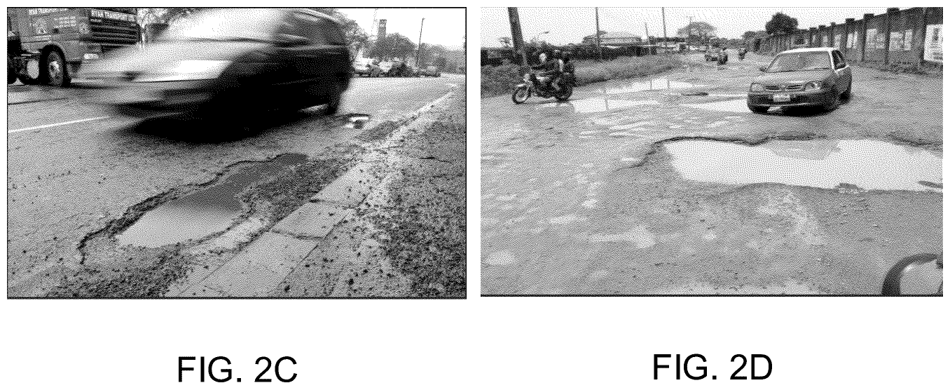

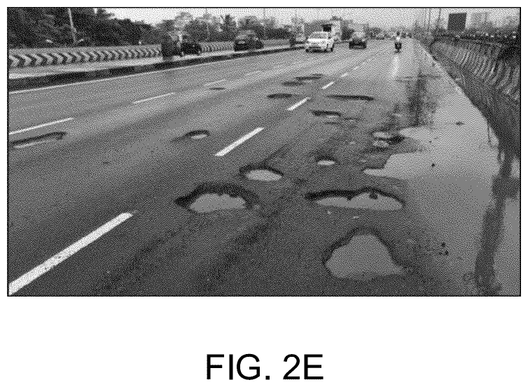

Referring now to FIGS. 2A-2E, during rain and other precipitation events, potholes fill with water which keeps the driver from being able to determine or distinguish the depth of the potholes, which causes the danger of the potholes to be difficult to discern. Additionally, during other weather or environmental conditions (e.g., at night, during fog/snow, in shadow, etc.) potholes can be difficult to detect and characterize. This can cause accidents due to panic braking/steering by the driver, injuries to occupants of the vehicle due to hitting the pothole, and/or damage to the vehicle from hitting the pothole. Similarly, other road hazards, such as cracks, bumps, uneven pavement, etc., present challenges for both human drivers and conventional sensor systems. Conventional technologies equipped on modern vehicles are also unable to estimate the amount of risk or danger a pothole poses (e.g., based on the depth of the pothole). For example, camera systems may struggle to discern the edges and depth of a pothole obscured by shadows or poor lighting or may misinterpret reflections from water or other surfaces. Radar and lidar systems might misinterpret the depth when scanning a damaged section of the road. In the case of an uneven road surface, such as a bump, conventional technologies may be unable to reliably judge the height of the bump. While small potholes may only cause minor damage to a vehicle, larger ones can cause collisions and severe injuries to drivers, passengers, cyclists, and pedestrians.

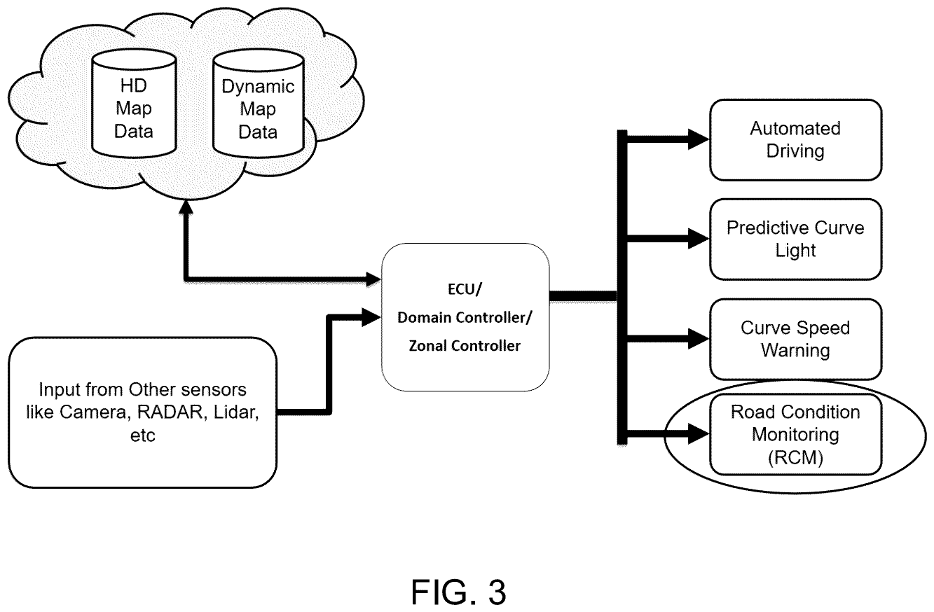

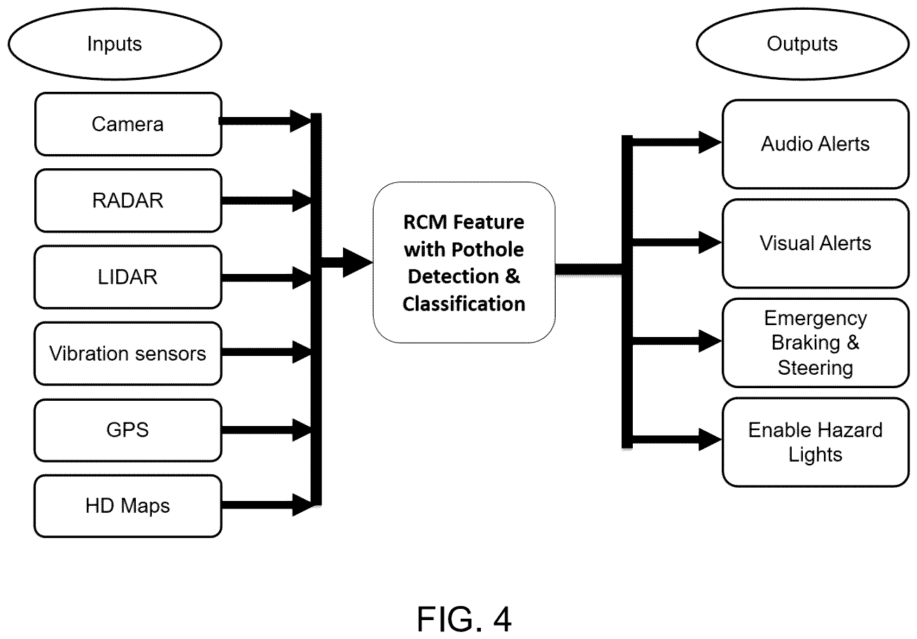

Referring now to FIGS. 3 and 4, implementations herein include a sensing system that gathers sensor data or information from a range of input sensors, HD maps, and/or other dynamic data. The collected data may be provided to a central computing unit (e.g., an ECU of the vehicle) where the data is analyzed to ascertain the presence of potholes on the road ahead of the vehicle and/or in a predicted trajectory of the vehicle. The system determines a size and/or shape of the pothole, and based on their size and shape, the identified potholes may be subsequently categorized for severity. Based on the categorization, the system may take appropriate actions to mitigate any risk.

The system may categorize or classify a pothole based on the diameter and/or the depth of the pothole relative to a threshold diameter and/or depth. For example, the system may categorize a pothole with a diameter of less than six inches and/or a depth of less than one inch as a “minor” pothole. As another example, the system may categorize a pothole with a diameter between six and twelve inches and/or a depth between one and three inches as a “major” pothole. As yet another example, the system may categorize a pothole exceeding twelve inches in diameter and/or three inches in depth as a “critical” pothole. These categories are merely illustrative, and the system may use different thresholds or a different number of categories.

In addition to or alternative to size and shape, the system may use the location to categorize the pothole. For example, the system will categorize a pothole located in the direct path of the vehicle's tires as more severe than the same pothole located near the edge of the roadway. As another example, the speed limit of the road, or other conditions that affect the speed of the vehicle or the driver's visibility (e.g., an overpass overhead) may affect the categorization. For example, a pothole on a freeway underneath an overpass may be categorized as more dangerous or severe than a similar sized pothole on a city road. Moreover, the system may define the shape of the pothole. For example, the system may determine that a pothole has an elliptical, circular, or irregular shape. The shape determination may inform the assessment of severity. For example, an elongated pothole, parallel with a direction of travel, may represent more or less risk than the same pothole rotated orthogonally to the direction of travel.

The proposed system may use inputs from multiple sensor systems to determine the road condition ahead. For example, the system may use inputs from one or more cameras (e.g., a forward-facing camera), radar sensors, lidar sensors, ultrasonic sensors, GPS sensors, vibration sensors, etc. Based on processing of this captured sensor data and based on data from HD maps, the system detects potholes along the road the vehicle is traveling and classifies each pothole into different threat categories based on the size, shape, and/or depth of the pothole (e.g., using image processing techniques and the like). The system may generate an alert for a driver of the vehicle (e.g., a visible alert displayed on a display of the vehicle, an audible alert, and/or a haptic alert). Additionally or alternatively, the system may control the vehicle to mitigate the risk of the pothole, such as by steering the vehicle, slowing the vehicle, adjusting a suspension of the vehicle, and/or enabling hazard lights.

The one or more cameras may capture images of the road surface, and the system analyzes the captured image data (i.e., frames of image data) to identify visual anomalies indicative of potholes. For example, the system may identify dark spots with irregular edges during dry conditions. Radar sensors may emit radio waves and measure the time and intensity of the reflected waves to gauge the distance, angle, and shape of objects, including changes in road elevation caused by potholes. Lidar sensors emit pulsed laser light and measure the time it takes for the light to reflect back, thus the lidar sensors create a detailed 3D map of the road surface, including pothole depth and contour. Ultrasonic sensors may emit high-frequency sound waves and measure the time of flight for the echoes, which the ultrasonic sensors use for close-range detection of road surface irregularities. GPS sensors may provide location data that the system can correlate with high-definition map information. Vibration sensors, such as accelerometers, may measure the vertical movement of the vehicle's suspension, and the vibration sensors allow the system to infer road roughness and the potential presence of potholes based on sudden jolts or vibrations. The system can cross-reference location data with HD map data, to enhance the detection capabilities. For example, if the GPS data indicates the vehicle is approaching a location where the HD map data indicates a previously detected pothole, the system can increase its sensitivity or provide an early warning to the vehicle control systems or the driver.

From the driver's perspective, the usage of this system may be similar to other active safety features already available in the market. For example, the driver may enable a road condition monitoring (RCM) feature that includes pothole detection and mitigation via actuating a button or other user input. Alternatively, the system may automatically be enabled (e.g., when the vehicle is turned on or started). When the feature is enabled, the drive may select a mode. For example, the system may provide a warning only mode and/or a warn/mitigate mode. In the warning only mode, the system may warn the driver about the presence of a pothole ahead either through visual warnings, audio warnings, and/or haptic warnings. Based on the warnings and the severity of the pothole, the driver is expected to take the appropriate actions (e.g., slow down, steer, halt, etc.). In the warn/mitigate mode, the system may take appropriate actions (e.g., braking, steering, etc.) in addition to the warnings based on the road condition and pothole detections. The response of the system may be dependent upon the classification of the pothole. For example, a pothole classified as minor may cause a warning and a minor decrease in speed for the vehicle. A major pothole may cause a warning and a substantial decrease in speed and/or change in steering. A critical pothole may cause a warning and a maximum decrease in speed and/or change in steering. Optionally, the system may change lanes or perform any other similar driving maneuver to avoid a pothole.

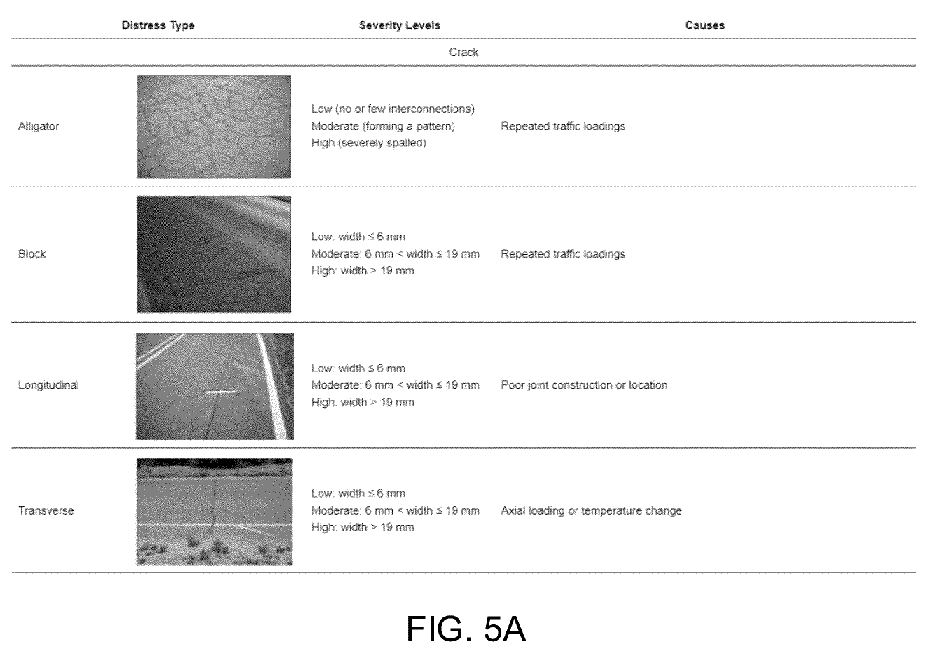

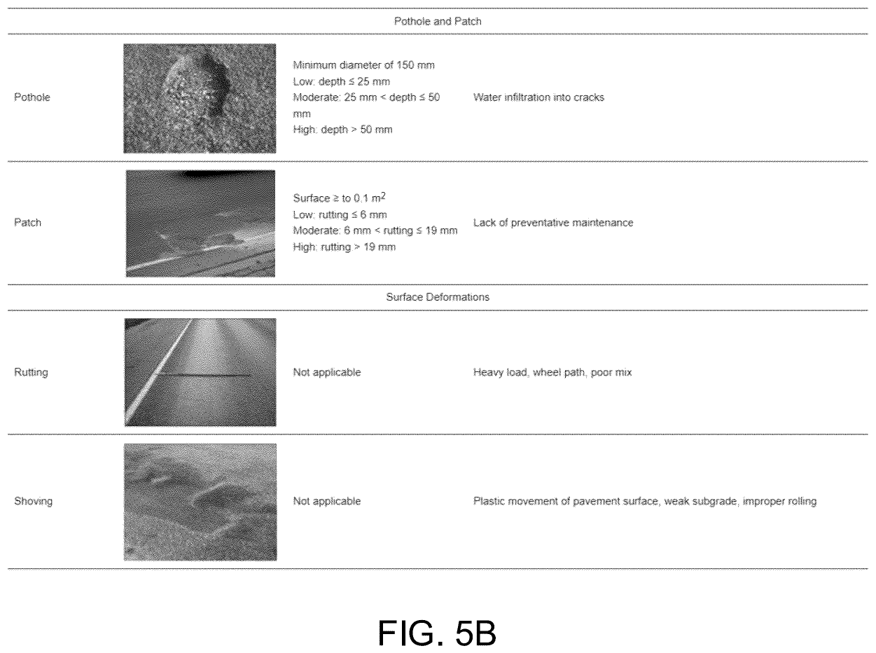

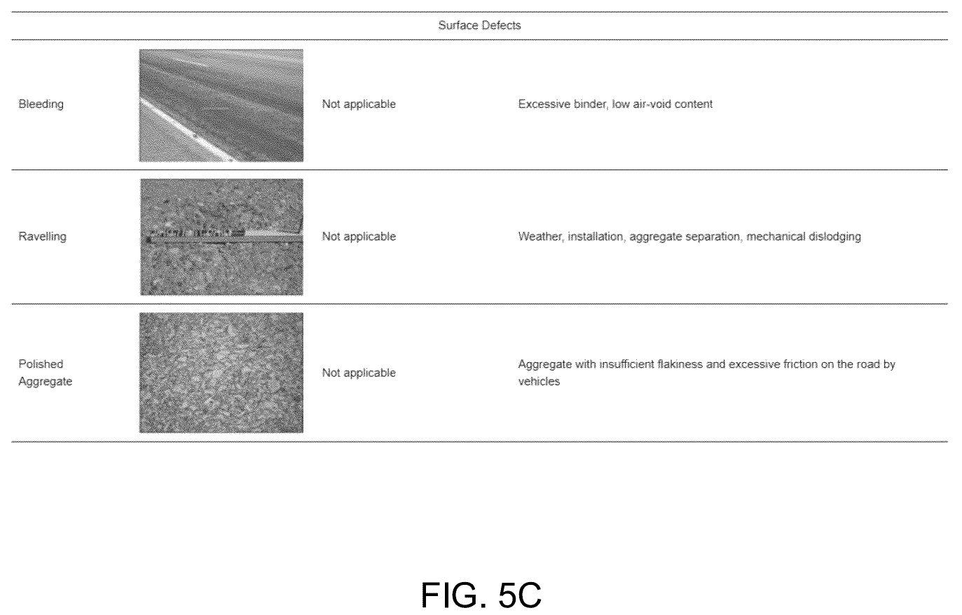

For some classifications, the system may perform some actions, while for other classifications, the system may perform different actions. For example, the system may not change steering for minor potholes and instead only change steering for major and critical potholes. The system may adjust the warning based on a severity of the pothole. For example, the system may generate a visual warning for minor potholes, while the system may generate a visual and audible and haptic (e.g., by vibrating the steering wheel) for major potholes. The system may detect potholes in a variety of road conditions. FIGS. 5A-5C illustrate a number of different pavement distress types and classifications. Examples of road damage include, but are not limited to, alligator cracking, block cracking, longitudinal cracking, transverse cracking, edge cracking, patching, raveling, rutting, shoving, bleeding, etc.

The system may generate different visual warnings based on the classification. For example, a minor pothole may be indicated by a small, yellow icon on the vehicle's display screen. A major pothole may cause the system to display a larger, orange icon, accompanied by flashing. A critical pothole may result in a large, red icon, along with bold text warning the driver of the immediate danger. The audible warnings can vary in tone, volume, and/or repetition rate. A minor pothole might trigger a single, soft audible tone or beep. A major pothole may generate a series of louder audible tones or beeps. A critical pothole may activate a continuous, high-volume alarm. The system may tailor the haptic feedback to the severity. A minor pothole classification may cause a slight vibration in the steering wheel. The system may increase the intensity of the vibration for a major pothole. For a critical pothole, the system may create a strong, pulsing vibration in the steering wheel, and/or seat, to ensure the driver receives the alert. The system may generate combinations of visual, audible, and haptic feedback. For example, a major pothole may activate a visual warning on the instrument panel, an audible chime, and seat vibrations simultaneously. In addition to varying warnings, the system may offer different levels of automated intervention. When avoiding a minor pothole, the system may slightly reduce power to the wheels, allowing for gentle deceleration. For a major pothole, the system may engage the braking system more aggressively to reduce vehicle speed quickly. For a critical pothole the automated system may perform an emergency braking maneuver to minimize impact with the pothole (i.e., to mitigate the wheel of the vehicle traveling over the detected pothole).

Optionally, the system determines or estimates a size and/or depth of potholes during dry conditions (i.e., when the potholes are not filled with water) and stores the location, size, and/or depth of the pothole at the HD map data. For example, the system stores, using the HD map data, the specific location and depth of a pothole measured during dry conditions. The system may maintain the HD map data at a local data repository (i.e., stored at the vehicle) or at a remote data repository (such as by communicating wirelessly with a remote server via wireless communication). The map data or other geographic-linked data may be stored at a database (e.g., a map database) populated or updated by any number of sources, such as by the equipped vehicle, any number of other vehicles (e.g., crowdsourcing), public road commissions, third-party entities, etc. The HD map data may include data only from the equipped vehicle. Alternatively, the HD map data is updated by any number of vehicles (i.e., a fleet of vehicles), thus allowing the system to pull HD map data for roads the vehicle may not have previously travelled. A vehicle may update the HD map data when the vehicle hits a pothole. For example, the HD map data may be updated based on a severity of the impact with the pothole (e.g., based on sensor data captured by a vibration sensor or the like). Optionally, the system may estimate a depth of a pothole based on a result of hitting the pothole (e.g., based on an amount of vibration from hitting the pothole). The system may then update the HD map data with the estimated depth of the pothole.

Thus, the system may initially detect potholes using any combination of sensor data and image processing techniques. For example, the one or more cameras capture images of the road surface, and the system analyzes these images to identify visual indicators of potholes, such as dark spots with irregular edges or changes in texture. Radar and lidar sensors contribute by detecting variations in road elevation and surface contours. Additionally, the system may monitor data from vibration sensors, such as accelerometers, mounted on the vehicle's suspension system. A sudden jolt or significant vertical acceleration detected by these sensors, especially when correlated with the vehicle's location, can indicate an impact with a pothole. The system may use this impact data in multiple ways. For example, the system may use such impact data to confirm the presence of a suspected pothole initially identified through visual or other sensor data. As another example, the system may log a new potential pothole location based solely on the impact, triggering a subsequent analysis of camera, radar, or lidar data to further characterize the hazard. When the system, via the fusion algorithm, confirms the presence of a pothole (either through initial detection or impact confirmation), the system may use a GPS sensor of the vehicle to pinpoint the pothole's precise geographical coordinates. The system may additionally use the image data, and/or the impact data, to estimate the dimensions of the potholes (i.e. the width and/or approximate depth) during these “dry” conditions when the pothole can be more accurately defined.

The system may record the location, size, and/or depth and other pertinent data of the detected pothole within the high-definition (HD) map database. The system may accomplish the storage of map data through any applicable method. For instance, the vehicle may maintain a local copy of the HD map, stored within the vehicle's onboard storage system. In this example, the system updates this local copy with the new pothole information. Alternatively, or additionally, the vehicle may transmit the pothole data wirelessly to a central, remote server that maintains a master HD map database. This central server may aggregate pothole data from multiple vehicles, creating a comprehensive and constantly updated map of road hazards. When the system stores the map data remotely, the vehicle may periodically download updates or cache relevant portions of the map data to its local storage. This caching may occur at predetermined intervals (e.g., daily, weekly) or when the vehicle is within range of a reliable wireless network (e.g., Wi-Fi at the owner's home or a cellular data connection). The system may select the area of the map to cache based on the vehicle's current location, planned routes, frequently traveled areas, or based on user input. The system may retrieve pothole data from either the local storage or the remote server (if real-time data is needed and an active connection is available), using the vehicle's current location to query the relevant map sections and proactively inform the driving or driver assist system and/or the driver of approaching hazards.

The system actively utilizes the high-definition (HD) map data, particularly during wet conditions, to determine a size, depth, and/or severity of potholes filled with water or other liquids/debris. For example, the camera may capture an image of a puddle on the roadway. The system processes the captured image data and determines a location of the puddle. The system may determine the location of the puddle via (or in combination with) other sensors, such as a radar or lidar sensor. The system may then query the HD map data using the determined location as a reference point. If the HD map data indicates the prior existence of a pothole at that precise location (or within a threshold distance of the precise location), the system infers the puddle is likely concealing a pothole. Because the HD map data contains information about that specific pothole's previously recorded dimensions, including depth, which were determined under dry conditions, the system leverages this pre-existing data to classify the severity of the water-filled pothole. The system does not have to rely on real time sensor data.

Thus, even when a pothole's depth is difficult to ascertain visually or with current sensor readings (e.g., due to water's reflective properties or other reasons), the system can access the HD map data to classify the water-filled pothole as minor, major, or critical based on the stored depth information. The system cross-references the real time sensor data to determine a location on the map. The system may cross-reference that location with pothole information stored in the map. The system will then use the pothole information to classify the detected pothole. The system may compare a size of the puddle with a stored size of the pothole, and update its classification based on differences in the size. For instance, if the puddle observed in real-time is significantly larger than the previously recorded pothole dimensions, the system might classify the pothole as more severe, assuming potential expansion or erosion. If the puddle is smaller than the stored pothole, then the classification may or may not be adjusted.

The system may facilitate updates to the HD map database to reflect pothole repairs. For example, when the vehicle traverses a location where the HD map data previously indicated a pothole, the system may actively analyze real-time sensor data from the cameras, radar, lidar, and/or vibration sensors. If the sensor data consistently indicates a smooth road surface, with no evidence of a pothole (e.g., no visual anomalies, no changes in elevation, no unusual vibrations), the system may infer that the pothole has been repaired. The system, upon making this determination, may automatically flag the corresponding entry in the HD map database for review. The system may immediately update the local copy of the map and then transmit a repair verification to a remote server hosting the master HD map database. This update may be subject to a verification process, such as requiring consistent “smooth road” readings from multiple vehicles over a period of time, before the pothole is officially removed from the master database. Alternatively, the system may receive manual confirmation (e.g., from an occupant of a vehicle) of a pothole repair. Road maintenance crews, after completing a repair, may use a dedicated interface (e.g., a mobile application or web portal) to directly update the HD map database, indicating the location and date of the repair. This manual input may trigger a similar verification process using vehicle sensor data, or, depending on the established protocols, it may directly update the map data.

Thus, the system provides pothole detection and classification, particularly advantageous when potholes are filled with water or other obstructions. Advanced Driver-Assistance Systems (ADAS) may possess the capability of monitoring road conditions and adapting vehicle suspension systems. However, these existing systems may fail to operate effectively in waterlogged conditions or in other conditions where the pothole is obstructed (e.g., by debris). In contrast, the described system uses data provided by HD maps, which the system can update during dry conditions or when the system detects a discrepancy between the map and sensor data. The system may receive real time data from a plurality of sensors such as cameras, radar, lidar, and/or vibration sensors. The system uses the HD map data as a further input during driving (including waterlogged conditions) and performs necessary actions if the system detects potholes in the path of the vehicle to improve safety and comfort. The system optionally cross-references real-time sensor data with HD map data. The system uses the HD map data to classify the detected water-filled pothole based on a stored depth and/or size of the pothole detected when the pothole was not filled with water. Based on the classification of the pothole, the system may generate one or more alerts (e.g., visual, audible, haptic) for occupants of the vehicle. Additionally, or alternatively, the system may control the vehicle based on the classification of the pothole, such as by automatically decreasing a speed of the vehicle, steering the vehicle to avoid the pothole, adjusting a suspension of the vehicle, and/or activating hazard lights of the vehicle. The system facilitates updates to the HD map database to remove potholes after repairs.

Thus, the system provides pothole detection and classification for potholes filled with water. Implementations herein use data provided by HD maps (which may be updated during dry conditions) as a further input during driving (including waterlogged conditions) and take necessary actions in case of potholes in the path of the vehicle to improve safety and comfort.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a sensor disposed at a vehicle equipped with the vehicular driving assist system, the sensor sensing exterior of the vehicle, wherein the sensor is operable to capture sensor data;
an electronic control unit (ECU) comprising electronic circuitry and associated software;
wherein sensor data captured by the sensor is transferred to and is processed at the ECU;
wherein the vehicular driving assist system, responsive to processing at the ECU of sensor data captured by the sensor and transferred to the ECU, detects a pothole ahead of the vehicle;
wherein the vehicular driving assist system, responsive to detecting the pothole, determines severity of the detected pothole based at least in part on geographic-linked data, and wherein the geographic-linked data comprises at least one selected from the group consisting of (i) size of the detected pothole, (ii) depth of the detected pothole and (iii) shape of the detected pothole; and
wherein, at least partially based on the determined severity of the detected pothole, at least one selected from the group consisting of (i) a driver of the vehicle is alerted, (ii) steering of the vehicle is controlled to mitigate a wheel of the vehicle traveling over the detected pothole and (iii) braking of the vehicle is controlled to mitigate the wheel of the vehicle traveling over with the detected pothole.

2. The vehicular driving assist system of claim 1, wherein the vehicular driving assist system determines severity of the detected pothole based at least in part on depth of the detected pothole.

3. The vehicular driving assist system of claim 1, wherein the vehicular driving assist system determines severity of the detected pothole based at least in part on size of the detected pothole.

4. The vehicular driving assist system of claim 1, wherein the vehicular driving assist system determines severity of the detected pothole further based at least in part on shape of the detected pothole.

5. The vehicular driving assist system of claim 1, wherein the sensor comprises at least one camera.

6. The vehicular driving assist system of claim 1, wherein the sensor comprises at least one radar sensor.

7. The vehicular driving assist system of claim 1, wherein the sensor comprises at least one lidar sensor.

8. The vehicular driving assist system of claim 1, wherein the determined severity of the detected pothole comprises one selected from the group consisting of (i) a minor pothole, (ii) a major pothole, and (iii) a critical pothole.

9. The vehicular driving assist system of claim 1, wherein the vehicular driving assist system, at least partially based on the determined severity of the detected pothole, generates an alert for the driver of the vehicle, and wherein the alert comprises at least one selected from the group consisting of (i) an audible alert, (ii) a visual alert, and (iii) a haptic alert.

10. The vehicular driving assist system of claim 1, wherein, at least partially based on the determined severity of the detected pothole, at least one selected from the group consisting of (i) steering of the vehicle is controlled to mitigate impact with the detected pothole and (ii) braking of the vehicle is controlled to mitigate impact with the detected pothole.

11. The vehicular driving assist system of claim 1, wherein the detected pothole is full of water.

12. The vehicular driving assist system of claim 11, wherein the geographic-linked data is representative of the detected pothole when the detected pothole was not full of water.

13. The vehicular driving assist system of claim 1, wherein the vehicular driving assist system retrieves the geographic-linked data from a database based on a current geographical location of the vehicle.

14. The vehicular driving assist system of claim 1, wherein the vehicular driving assist system updates the geographic-linked data at a database based at least in part on the captured sensor data.

15. The vehicular driving assist system of claim 14, wherein the database is stored remotely from the vehicle, and wherein the vehicular driving assist system updates the geographic-linked data via wireless communication.

16. The vehicular driving assist system of claim 14, wherein the vehicular driving assist system updates the geographic-linked data to indicate presence of a pothole.

17. The vehicular driving assist system of claim 1, wherein the vehicular driving assist system determines a location of the detected pothole, and wherein the vehicular driving assist system retrieves the geographic-linked data from a database based on the determined location of the detected pothole.

18. A vehicular driving assist system, the vehicular driving assist system comprising:
a forward-viewing camera disposed at a vehicle equipped with the vehicular driving assist system, the forward-viewing camera viewing exterior of the vehicle, wherein the forward-viewing camera is operable to capture image data;
an electronic control unit (ECU) comprising electronic circuitry and associated software;
wherein image data captured by the forward-viewing camera is transferred to and is processed at the ECU;
wherein the vehicular driving assist system, responsive to processing at the ECU of image data captured by the forward-viewing camera and transferred to the ECU, detects a pothole ahead of the vehicle;
wherein the vehicular driving assist system, responsive to detecting the pothole, determines severity of the detected pothole based at least in part on geographic-linked data, and wherein the geographic-linked data comprises depth of the detected pothole; and
wherein, at least partially based on the determined severity of the detected pothole, at least one selected from the group consisting of (i) a driver of the vehicle is alerted, (ii) steering of the vehicle is controlled to mitigate a wheel of the vehicle traveling over the detected pothole and (iii) braking of the vehicle is controlled to mitigate the wheel of the vehicle traveling over with the detected pothole.

19. The vehicular driving assist system of claim 18, wherein the vehicular driving assist system determines severity of the detected pothole based at least in part on size of the detected pothole.

20. The vehicular driving assist system of claim 18, wherein the vehicular driving assist system determines severity of the detected pothole further based at least in part on shape of the detected pothole.

21. The vehicular driving assist system of claim 18, wherein the determined severity of the detected pothole comprises one selected from the group consisting of (i) a minor pothole, (ii) a major pothole, and (iii) a critical pothole.

22. A vehicular driving assist system, the vehicular driving assist system comprising:
a sensor disposed at a vehicle equipped with the vehicular driving assist system, the sensor sensing exterior of the vehicle, wherein the sensor is operable to capture sensor data;
an electronic control unit (ECU) comprising electronic circuitry and associated software;
wherein sensor data captured by the sensor is transferred to and is processed at the ECU;
wherein the vehicular driving assist system, responsive to processing at the ECU of sensor data captured by the sensor and transferred to the ECU, detects a pothole ahead of the vehicle, and wherein the detected pothole is full of water;
wherein the vehicular driving assist system, responsive to detecting the pothole, determines severity of the detected pothole based at least in part on geographic-linked data, and wherein the geographic-linked data is representative of the detected pothole when the detected pothole was not full of water, and wherein the geographic-linked data comprises at least one selected from the group consisting of (i) size of the detected pothole, (ii) depth of the detected pothole and (iii) shape of the detected pothole; and
wherein, at least partially based on the determined severity of the detected pothole, a driver of the vehicle is alerted.

23. The vehicular driving assist system of claim 22, wherein the sensor comprises one selected from the group consisting of (i) a camera, (ii) a radar sensor and (iii) a lidar sensor.

24. The vehicular driving assist system of claim 22, wherein, at least partially based on the determined severity of the detected pothole, at least one selected from the group consisting of (i) steering of the vehicle is controlled to mitigate a wheel of the vehicle traveling over the detected pothole and (ii) braking of the vehicle is controlled to mitigate the wheel of the vehicle traveling over with the detected pothole.
